(19) United States
(12) Patent Application Publication
(10) Pub. No.: US 2005/0220598 A1
(43) Pub. Date: Oct. 6, 2005

(54) Wheel-lift device with tongue for towing vehicles

(76) Inventor: Arden Royce Shubert, Fort Collins, CO (US)

Correspondence Address: Arden Royce Shubert, 1920 Sheely Drive, Fort Collins, CO, 80526, US

(21) Appl. No.: 11/067,806

(22) Filed: Feb. 28, 2005

Related U.S. Application Data
(63) Continuation-in-part of application No. 10/294,258, filed on Nov. 14, 2002.

(51) Int. Cl. B65G 1/00

(52) U.S. Cl. 414/563

(57) ABSTRACT

A wheel-lift hitch device for towing a vehicle, particularly a hitch assembled from several components to surround and carry an axle of a vehicle to be towed in which the device becomes an appendage to that vehicle. The appendage lifts vehicle using an integral jack and serves as a rigid tongue to hitch vehicle to a tow truck. The hitch is the only horizontal and the only vertical axis between vehicle and tow truck.

### CROSS-REFERENCE TO RELATED APPLICATION:

This is a Continuation-in-Part of application Ser. No. 10/294,258 filed Nov. 14, 2002 and now U.S. Pat. No. ______, granted ______.

### FEDERALLY SPONSORED RESEARCH

Not Applicable

### SEQUENCE LISTING OR PROGRAM

Not Applicable

### BACKGROUND OF THE INVENTION—FIELD OF THE INVENTION

This invention relates to a wheel-lift device for towing vehicles, and particularly to a device assembled from several parts that surround an axle of a vehicle to be towed, in which the device becomes a rigid appendage to that vehicle and, having that appendage serve as a tongue to hitch to a second vehicle, allows the first vehicle to be towed by the second as a two-wheel cart.

### BACKGROUND OF THE INVENTION

Wheel-lift towing of vehicles has a history of less than four decades. Wagner, U.S. Pat. No. 3,182,829, May 1965, gave us a vehicular lifting yoke. His yoke taught us to use the axle of the towed vehicle as the horizontal axis for articulation between the towed and towing vehicle. It remains common practice to date.

That design has an inherent problem. The location of the horizontal pivot determines the location of where the weight of the towed vehicle is transferred to the tow truck. Truck manufacturers prefer that a truck's load be carried between the axles or close to the rear axle. A recommended ratio of no more than forty percent of cargo weight should be carried behind the axle. This design carries all of the cargo weight some distance behind the axle and the weight of the wheel-lift equipment as well is carried behind the truck's axle in most designs.

Earlier wreckers, especially before about 1980, used a tow bar or a sling that attached to the bumper or the end of the frame of the towed vehicle. The weight of the vehicle was carried by the wrecker at the tow bar that had a working position of several feet behind the end of the truck. In comparison that is about half the distance from the axle that many wheel-lifts carry their load. To compensate for this shift of the load rearward, wreckers are generally at least one and a half times the length of earlier tow trucks and weigh substantially more.

State commercial drivers license manuals teach drivers that they are responsible for their load and that poor distribution of weight can make vehicle handling unsafe. Tow truck operators are generally required to have commercial drivers licenses and to know these rules. It seems inevitable that towmen will be summoned to court sometime in the future for knowingly operating unsafe vehicles.

The industry seems aware of the challenges it faces carrying towing loads far behind tow trucks' rear axles but it appears to have not yet found a solution that addresses the weight transfer problem. An example appears in the Winter 2002 edition of the Write Carrier & Wrecker Quarterly, Volume 11, Number 1, Page 20, a publication of the Jerr-Dan Corporation, a major manufacturer of towing equipment.

This article describes a user's need for equipment to tow a fire truck with a front axle weight of 21,350 pounds, a front axle set back of 10 feet from the front bumper, and the fire truck having a bucket and snorkel assembly that extends 7 feet ahead of the front bumper. The fire trucks have low hanging components within the underbelly of the fire truck that the towing boom needed to pass under without contact when turning. The manufacturer only approves the axle as a pickup point. The fire trucks are too high to transport on trailers.

This customer's problem invites a comparison between the industry's state of art and the present invention. Their solution was to use a modified heavy-duty Under-lift carrying the fire truck by the axle using a four stage rigid boom extending behind the truck's tri-axles. The 21,350 pound front axle load of the fire truck is carried about 20 feet behind the center of the tow truck's rear suspension. The rigid lifting boom acts as a lever increasing the 21,350 pound axle weight on the Under-lift's axles. Wrecker trucks have a high tare weight. The combined load exceeds the tri-axle legal load weight. The article acknowledges that this combination will be an oversize, over-height, and overweight load.

The present invention shifts both horizontal and vertical axes between the tow truck and the fire truck from the rear of the lifting arm to the front of that arm. The action of the lever on this wheel-lift hitch device arm transfers most of the front axle weight to the tow truck, but a percentage of that weight will be transferred to the rear axles of the towed unit. In this example the fire truck could be towed using the present invention by a tandem axle tractor equipped with a pintle hook hitch and be of legal axle weight on the tow truck's axles. The present invention has no arm that pivots under the load. The load may be carried lower because less clearance beneath the truck is required and the towed load may be under legal height limits. A shorter tow truck can be used because it is not necessary to have excessive tow truck length to counter balance a load carried far behind the axles of the tow truck. The combination can be within legal length requirements.

An additional problem with the present designs of wheel-lift tow trucks of all sizes and classes is that all carry the load at the end of a boom behind the truck axle. The boom serves as a lever. A lever amplifies motion and force. That amplified motion can cause movement and forces in excess of design capability of the towed vehicle. An irregular or undulating road surface can cause extreme vertical movement in the suspension of the towed vehicle carried on a wheel-lift and retained to that boom and can result in damage to that vehicle.

To avoid some of this damage users can raise the boom to relatively high angles from horizontal to provide more clearance between the boom, its pivot, and drive train components of the towed vehicle. This action causes a different problem. Many tow truck designs advertise a wheel-lift boom angle of 10 to 15 degrees above horizontal. When a boom is raised to that angle, the pivot pin between the boom and the transverse bar of the wheel-lift also tilts forward at a like angle. The forward tilt of the transverse bar's pivot pin causes the towed vehicle to warp in a turn in relation to the attitude of the tow truck. The actual warp between the inside and outside ends of the transverse bar in a 45 degree turn may be 12 inches or more when the boom is carried at these angles. Cullum, U.S. Pat. No. 5,709,522, January 1998, introduced a double pivot crossbar “capable of rotational movement in both horizontal and vertical planes permitting stress reduction in both the tow truck assembly and the tow truck chassis . . . .” Presumably it may also reduce stress to the towed vehicle that is generally less strong than towing equipment.

Available alternatives to a wheel-lift tow truck are limited. Car carriers are widely used by professional towing operators. Their size is generally a disadvantage. Three car lengths of space are generally required to load or unload a car carrier compared to two car lengths of space with most wheel-lift trucks. That space requirement can limit the efficiency of a car carrier in an urban environment. A second problem with car carriers is the difficulty of damage-free loading of a vehicle with front wheels locked at an angle. Force rather than finesse generally prevails and the locked vehicle is dragged onto a truck causing strain on mechanical components. Alm, U.S. Pat. No. 5,779,431, Jul. 1998, introduced a wheel-loading device used on a car carrier body to facilitate damage-free loading. It appears to be the only wheel-lift design at this time that carries its load primarily between the axles of the truck during transport.

Car dollies also carry vehicles on their own wheels and suspension. Car dollies have only limited capabilities for handling damaged or inoperable vehicles. Most designs include two vertical axes, one at the hitch and a second at the wheels of the towed vehicle. Few operators are able to back up such a combination and commercial use is therefore limited.

A wheel-lift device seldom seen in the United States is a truck mounted rotating boom equipped with a rotating lift frame at its outer end. The lift frame is maneuvered over the vehicle and wheel supports attached to the lift frame are placed under each wheel. The vehicle is then hoisted onto the truck body. It appears to be an especially efficient approach for the damage-free removal of illegally parked vehicles.

A different under-lift towing device is an alternative to the traditional wheel-lift or under-lift. Marketed under the trade name “Tru-Hitch”, it is an under-lift for heavy duty towing that uses the 5th wheel of a semi-truck tractor as the horizontal and vertical towing axes. It was introduced into the commercial market about 1990 and is a towing system that carries the weight of the towed vehicle above the axle of the tow truck. It lacks convenience for use in its method of attachment to the vehicle to be towed.

The automotive wheel-lift has long been used as both horizontal and vertical axes between the towed vehicle and the tow truck. There appears to be no precedent for a wheel-lift to not use the vehicle wheels as a horizontal axis and instead immobilize it and use the immobilized axle to support a fixed tongue. A wheel-lift hitch does not appear to have been used to transfer the horizontal and vertical axes to the front by a tongue to a hitch ahead of the towed vehicle. There is no precedent for a wheel-lift device that is assembled at the vehicle axle creating a tongue with which to tow that vehicle and then carrying it on its own wheels and suspension.

Devices for lifting a heavy tongue from the ground into a towing hitch on a truck are readily available and in widespread use, especially in the modular and mobile home transporting business. Charles Weber, U.S. Pat. No. 4,000,911, January 1977, introduced a hitch head that was hydraulically adjustable laterally, vertically, and longitudinally. Randall Weber, U.S. Pat. No. 4,946,182, August 1990, followed with an even more versatile boom type hitch. Those, and other hitches with similar capability, are readily adaptable for use with the present invention. Strap winches integral within small booms will offer a convenient and lightweight solution for raising the tongue to a hitch for many users.

The present invention is usually attached to the vehicle to be towed before it is attached to the tow truck so this hitch device conforms to all terrain conditions. The tow truck or the carrier attaches to the hitch device. Powered wheel-lifts often cause damage. Young, U.S. Pat. No. 5,951,235, September 1999, describes problems that all in the industry face and offers a powered solution to it. The present invention, a manually maneuvered hitch device, is powerless to cause damage to a vehicle and can perform similar tasks.

Under the best conditions tow truck operation is seldom without some physical effort. Sophisticated self-loading towing equipment requires the operator to check and perhaps secure the load before departing on a high-speed tow on public roadways. Most towing units still require installation of wheel chocks and retaining straps or chains. The present invention recognizes that fact and includes such tasks in the assembly of the wheel-lift hitch onto the vehicle to be towed. Many wreckers and tow trucks now carry towing dollies that require assembly, often at accident scenes. Light-duty embodiments of the present invention will be comparable in weight to the advertised weights of towing dollies and will require about the same time and effort to assemble.

It is understood that this device is adaptable to any hitch design that has an adequate vertical load rating in addition to adequate towing capacity. Pintle hooks and a variety of 5th wheel hitches are preferred over most ball hitches that are limited by low vertical load ratings. Gooseneck hitch adaptors can be used with models that have an adjustable length tongue and will offer better load transfer at some cost to convenience. Weight transfer hitches can be accommodated and truck mounted tongues are expected to be developed.

### BACKGROUND OF INVENTION—OBJECTS AND ADVANTAGES

The main object of this invention is to provide a wheel lift device that, without moving parts and when assembled around wheels on an axle of a vehicle, becomes an appendage to that vehicle which can be used as a tongue to tow the vehicle as a cart behind a tow truck and to carry that vehicle on its own suspension.

A second object of the invention is to introduce a universal wheel lift design that can be used to lift and carry one axle of almost all vehicles having at least 2 axles with wheels and tow that vehicle allowing it to ride on its own suspension.

A third object of the invention is to provide an automotive wheel lift device to the industry that is as easy to assemble as a car dolly regularly used by those in the industry and of comparable or less weight.

Another object of the invention is to introduce a wheel lift design that reduces the distance that the towing load is carried behind the axle of the tow truck thus providing safer and improved handling characteristics for the tow truck.

An additional object of the invention is to create a design that can be easily manufactured without specialized machinery.

A further object of the invention is to create a tool with simple and logical design, the proper use of which might be taught to almost any user without extensive repetition.

Additional objects and advantages of this invention will be set forth in the following description. They will in part be obvious from the description or may be learned by practice of the invention.

### SUMMARY

The present invention provides a wheel-lift hitch having a hinged tongue that, when assembled around a vehicle axle, carries that axle and serves as a tongue to tow vehicle by a tow truck, tongue having an integral jack to straighten hinged arm thereby raising vehicle into towing position.

### BRIEF DESCRIPTION OF THE SEVERAL VIEWS OF THE DRAWINGS

FIG. 1 is a perspective view of assembled wheel-lift device with left chain in place.

FIG. 2 is a perspective view of hitch housing and hinged arm in raised position.

FIG. 3 is a perspective view of an extended brace and extended wheel chock.

FIG. 4 is a perspective view of partially folded brace and partially folded wheel chock.

FIG. 5 is a perspective view of folded brace and folded wheel chock for transport.

### REFERENCE NUMBERS USED IN DRAWINGS

| | |
|---|---|
| 20-Wheel-lift Device | 22-Tongue Assembly |
| 24-Transverse Beam Assembly | 26 L & R-Rear Chock Assembly |
| 28-Chain | 30-Hitch |
| 32-First Arm | 34-Arm Hinge |
| 36-Second Arm | 38-Jack Ram |
| 40-Jack Pump | 42-Hydraulic Coupler |
| 44-First Pin | 46-Second Pin |
| 48-First Arm Lock | 50-Second Arm Lock |
| 52-Hitch Housing | 54-First Chain Latch |
| 56-Fasteners | 58-Transverse Beam |
| 60 L & R-Front Chock Assembly | 62-Socket |
| 64-Second Chain Latch | 66-Anchor |
| 68-Chock Latch | 70 L & R-Leg |
| 72 L & R-Folding Chock | 74-Third Chain Latch |
| 76-Chock Hinge | 78-Brace Stop |
| 80 L & R-Brace | 82-Brace Hinge |
| 84-Chain Guide | 86-Chain Binder |

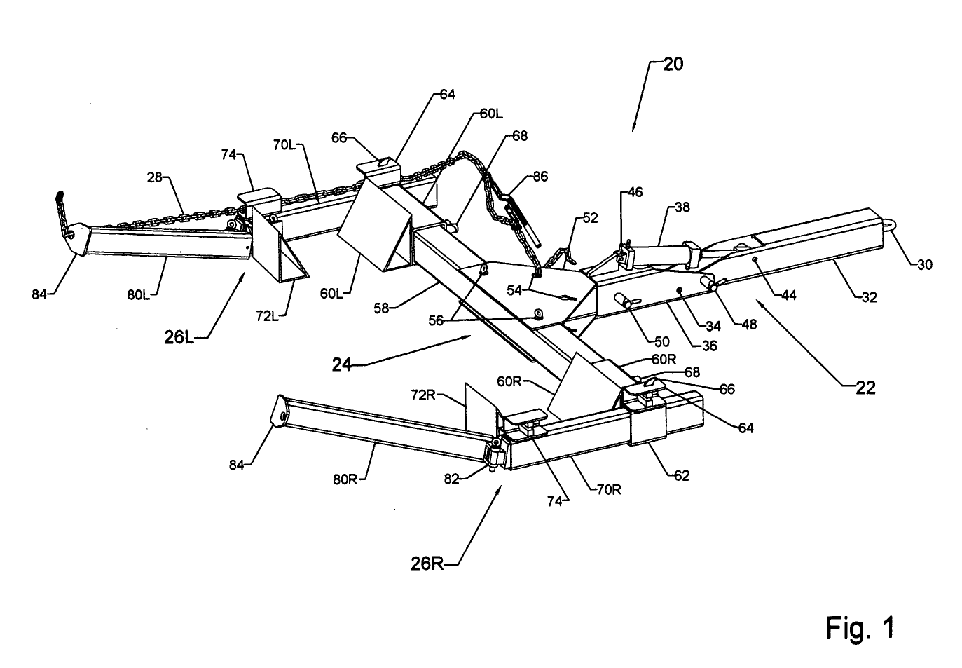

### DETAILED DESCRIPTION—FIGS. 1-6

FIG. 1 shows wheel-lift device (20) that joins a tongue assembly (22) with transverse beam assembly (24) forming a rigid “T”-shaped towing frame. Rear chock assemblies (26 L & R) hold vehicle wheels against front chocks (60 L & R). Two chains (28) are used, chain course is illustrated on left side of wheel-lift device (20). The series of chain latches and guide are shown without chain on right side. Chain (28) courses forward from transport chain anchors at each side of vehicle, through chain guides (84), third chain latch (74), second chain latch (64), and first chain latch (54). Chain binders (86) are tools used to make chains (28) taut when connecting wheel-lift device (20) to vehicle and further to secure front segments of chains (28) during transport.

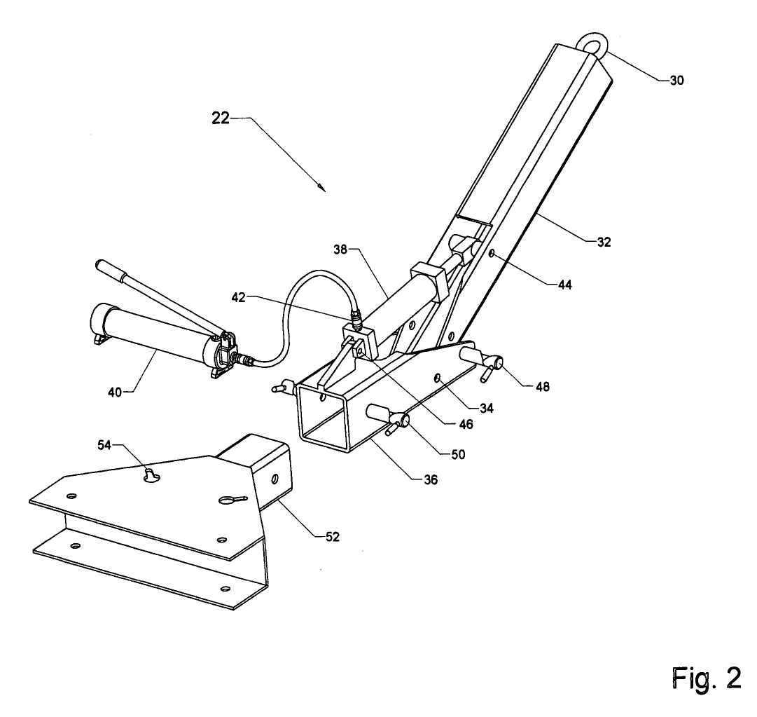

It is preferred that wheel-lift device (20) be partially assembled and connected to tow truck before being attached to vehicle. Hitch (30) connects tongue assembly (22) to tow truck when hinged as shown in FIG. 2. Transverse beam assembly (24) joins tongue assembly (22) at hitch housing (52). Vehicle is positioned with wheels against front chock assemblies (60 L & R). Assembly of wheel-lift device (20) is completed and vehicle secured to it. Axle of vehicle is raised into towing position using jack ram (38) extending between first pin (44) on first arm (32) and second pin (46) on second arm (36) by connecting it to jack pump (40) by coupler (42). Extending jack ram (38) by pumping jack pump (40) rotates first arm (32) downward on arm hinge (34) where it is secured when straight by first arm lock (48). Pressure is relieved and pump (40) is then separated at coupler (42) and stored.

An alternative sequence securely connects wheel-lift hitch device (20) to vehicle first. Tow truck is then backed into position to attach hitch (30) and vehicle is raised as previously described. Disabled vehicles are likely to be connected to a tow truck using this sequence.

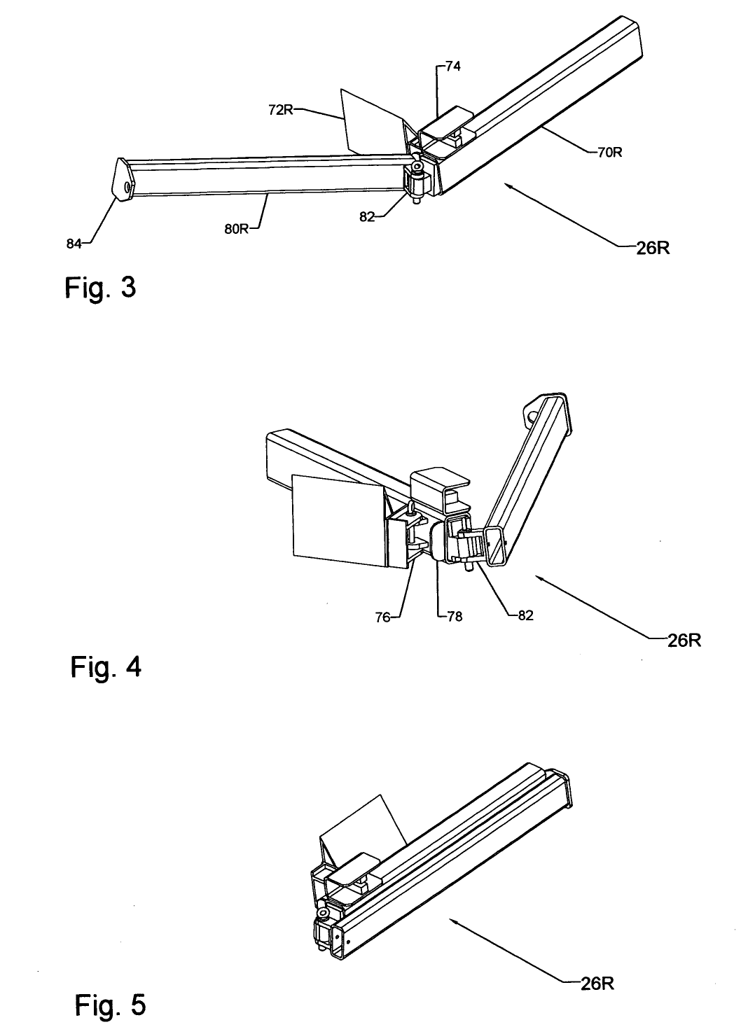

In more detail, tongue assembly (22) joined to hitch housing (52) by second arm lock (50), illustrated in FIG. 2, is selectively attached to transverse beam assembly (58) using fasteners (56). Hitch housing (52) incorporates first chain latches (54). First chocks (60 L & R) are mounted as sleeves over ends of transverse beam (58) and are adjustable for width, and secured in any of several positions by chock latches (68). First chocks (60 L & R) are further comprised of sockets (62), second chain latches (64). Anchors (66) provide chain binders (82) a fixed support so they may be used as tools to pull chains (28) taut before securing chains in second chain latches (68). FIGS. 3, 4, and 5 show rear chock assembly (26R) extended, partially folded, and fully folded for transport. Rear chock assembly (26R) is comprised of leg (70R), folding chock (72R), and brace (80R), with chain guide (84) fixed to outer end. Brace (80R) adds length and leverage to counteract torque developed by tongue assembly (22). Legs (72 L & R), inserted into sockets (62) from the rear, pass tongue forces rearward past axle to vehicle chassis. Legs (72 L & R) also hold vehicle's wheels between folding chocks (70 L & R) and front chock assemblies (60 L & R) in conjunction with a segment of chain (28) between third chain latch (74) and second chain latch (64) that holds pairs of chocks together when carrying vehicle's wheels.

Folding chocks (72 L & R) rotate on chock hinges (76) between a right angle to legs (70 L & R) for work and a storage position parallel to legs (70 L & R) for transport. Braces (80 L & R) are pivotally mounted to and rotate on brace hinges (82 L & R) in arcs exceeding 180 degrees between work and storage positions. Braces (80 L & R) extend behind legs (70 L & R) for work and fold to the opposite side from folding chocks (72 L & R) for travel. Brace rotation is limited in one direction by brace stop (78). Both pin and gudgeon of hinges (82 L & R) are tilted slightly forward at the top when folded so that braces (80 L & R) tilt upward from parallel when rotated 180 degrees. Legs (70 L & R), folding chocks (72 L & R), and braces (80 L & R) fold into compact forms for storage.

Chains (28) are first connected to vehicle chassis at transport chain anchors or to a suitable chassis or suspension component. Chains (28) function differently as they course forward through chain guides (80), third chain latch (74), second chain latch (64), and to first chain latch (54). Passing freely through chain guides (84), chains (28) are secured in third chain latch (74). Rear chock assemblies (26 L & R) are pulled forward against vehicle wheels by using chain binder (86) hooked between chain (28) and anchor (66). Chains (28) are held taut at transverse beam assembly (24) by latching into second chain latches (64). Chains (28) continue forward from second chain latches (64) over a suspension or chassis component of the vehicle and downward to engage first chain latch (54). Chain binder (86) is used to pull and hold chain (28) taut for transport. It is acknowledged that nylon straps with strap winches may replace chains (28) between second chain latches (64) and first chain latches (54).

Vehicle's axle is raised into towing position by having hitch (30) connected to tow truck and wheel-lift device (20) attached to vehicle to be towed. Hitch (30) serves as a front pivot and vehicle's trailing axle as a rear pivot when tongue assembly (22) rotates downward on first hinge (34) lifting vehicle's axle. Tow truck then tows vehicle on its trailing axle.

It is preferred, but perhaps not required, that chains (28), used with chain binders (86), compress vehicle suspension against upward travel stops, immobilizing any suspension movement. Wheel-lift device (20) must act as a rigid appendage to the vehicle when used as a tongue for towing.

Each of the four component assemblies of wheel-lift device (20) can be constructed for ease and convenience for transport and use. It is recognized that transverse beam assembly (24) can be constructed in one piece that includes hitch housing (52) if intended use is limited to similar vehicles.

It is further recognized that a vertical axis between tongue assembly (22) and beam (58) can be incorporated into hitch housing (52). Selective use of this axis for aligning tow truck with hitch (30) provides added convenience to users. Axis would be securely locked while towing.

Any tow truck using this hitch only requires that the chassis and hitch have adequate capacities. Wheel-lift device (20) therefore, is compatible for use with conventional tow trucks, service vans, larger motor homes with adequate rear axle capacity, and even gooseneck or semi trailers. This device has no pivot under the towed vehicle and has no parts that move after assembly and connection to vehicle and tow truck. Higher maintenance components such as tires, bearings, lights, and mechanical latches other than pins need not be used with this device.

### CONCLUSIONS, RAMIFICATIONS, AND SCOPE OF INVENTION

The present invention provides a universal attachment scheme for vehicles having four wheels on two axles using a wheel-lift device. Components are generally of a size and weight that can be handled by one person. It is expected that proper use of this device can be easily taught to users.

The hinged tongue is a simple lifting device and future versions may have jack rams totally enclosed within arms. It is expected that different devices may be used to join the tongue to the transverse beam. An example is a connector allowing the arm to selectively pivot on a vertical axis within a limited arc thus providing easier alignment between the towed vehicle and tow truck, motor home, or rental truck that is used for towing.

Folding wheel chocks make storage and handling of rear chock assemblies more convenient. Braces having extendable sections incorporating chain guides or other fasteners are compatible with this device. Braces may have telescoping sections that extend to car axle dollies. The present embodiment shows a single fixed hinge that is oriented with a slight forward tilt. It is expected that some braces will use combinations of hinges. Wheel chock assemblies with some form of braces incorporating chain guides will be widely used on front-pivot towing equipment.

Military use is possible. The present invention can transform any truck, trailer, or tracked vehicle equipped with a compatible hitch into a tow vehicle for HumVees or similar equipment. It has been reported that an increased capacity for towing such vehicles is needed by several military branches.

1. A wheel lift device forming a rigid tongue for hitching a vehicle to a tow truck, and pulling said vehicle on a trailing axle, said device comprising:
(a) a tongue having an arm connecting a hitch to a transverse beam;
(b) said arm having first chain latches;
(c) said beam having arm mounting brackets, first wheel chocks, second chain latches and sockets for holding legs;
(d) said legs having second wheel chocks, third chain latches, and braces having chain guides at distal ends;
(e) means for releasable attaching said vehicle to said wheel lift device for towing.

2. A rigid wheel lift device as described in claim 1, wherein said tongue further comprising:
(a) said arm having a transverse hinge within its length;
(b) jack device for bending said hinged arm;
(c) lock for holding said arm in transport position;
(d) providing a means for raising said vehicle for towing on its trailing axle.

3. A rigid wheel lift device as defmed in claim 1, wherein said legs further comprising:
(a) said second chocks pivotally attached to said lateral elements and foldable against said legs for transport;
(b) lateral elements to support said second wheel chocks and said braces;
(c) said braces pivotally attached to said lateral elements by hinges fixed near said second wheel chocks;
(d) said braces holding said chain guides some distance behind said second wheel chocks during use;
(e) means to secure a wheel of said vehicle between first and second chocks.

4. A rigid wheel lift device as defined in claim 1, wherein the attachment means comprising chains attached to anchor points on said vehicle and coursing through said chain guides and latches, thereby attaching said vehicle to said rigid wheel lift device.
